(19) United States
(12) Patent Application Publication
(10) Pub. No.: US 2024/0218904 A1
(43) Pub. Date: Jul. 4, 2024

(54) ROLLING ELEMENT GUIDE RAIL, METHOD FOR MANUFACTURING ROLLING ELEMENT GUIDE RAILS, LINEAR GUIDE RAIL, LINEAR BALL BEARING AND LINEAR GUIDE CARRIAGE

(71) Applicant: FESTO SE & CO. KG, Esslingen (DE)

(72) Inventor: Heinz GREINER, Ebersbach (DE)

(21) Appl. No.: 18/563,729

(22) PCT Filed: May 25, 2022
(86) PCT No.: PCT/EP2022/064306

§ 371 Date: Nov. 22, 2023

(30) Foreign Application Priority Data
May 26, 2021 (DE) 10 2021 002 732.9

(51) Int. Cl. F16C 29/00; F16C 29/06

(52) U.S. Cl. CPC F16C 29/005; F16C 29/0602; F16C 2220/70

(57) ABSTRACT

Rolling element guide rail for a linear rolling bearing, having a profile body on which at least one rolling element running surface extends along a straight line of movement with a constant profiling and is designed for a rolling movement of a rolling element, and on which two guide surfaces each extend along the straight line of movement with a constant profiling and are designed to be accommodated in a guide groove of a bearing housing, a breaking edge being formed on at least one of the guide surfaces.

The invention relates to a rolling element guide rail, a method for manufacturing rolling element guide rails, a linear guide rail, a linear ball bearing and a linear guide carriage.

Profile rail guides are based on the transfer and further development of the principle of four-point wire race bearings, by Erich Franke as published in DE 1 042 976 B, in which the raceways were formed from hard wires, to linear guides.

Guideways and bearings of this and similar designs use drawn wires, usually reduced in hardness, without reworking for tasks with limited precision. More demanding solutions in terms of precision and service life are reground before or after installation in the mounting body.

Such solutions are particularly common in conjunction with aluminum or other mounting materials like soft steel or plastic.

Since four-point bearings and four-point guidance systems do not allow for narrow osculation due to friction, requirements for higher load-bearing capacity are met primarily by multi-row two-point bearings and by roller bearings, track or cam roller guidance systems or recirculating roller guidance systems for unlimited strokes and cage guidance systems with limited strokes. Drawn or cold-rolled profiles replaced the conventional wires.

DE 10 2004 018 820 A1, in which drawn steel profiles are inserted into an aluminum base body, DE 90 11 444 U1 with a further design and DE 10 2014 119 113 B3 are examples of such a further development.

### SUMMARY OF THE INVENTION

The task of the invention is to provide a rolling element guide rail and a method for manufacturing rolling element guide rails with which a high load capacity can be ensured in conjunction with cost-effective manufacture.

This task is solved for a rolling element guide rail for the use for a linear rolling bearing in that the rolling element guide rail has a profile body on which at least one rolling element running surface extends along a straight line of movement with a constant profiling and is designed for a rolling movement of a rolling element, and on which two guide surfaces each extend along the straight line of movement with a constant profile and are designed to be accommodated in a guide groove of a bearing housing, with a breaking edge being formed on at least one of the guide surfaces.

In order to enable the cost-effective manufacture of such a rolling element guide rail from a highly resilient material such as a rolling bearing steel or a ceramic material, it is intended that several rolling element guide rails are machined together like a panel, i.e. a one-piece arrangement of several rolling element guide rails. In view of the high surface pressures that can be applied by the rolling elements, for example bearing balls or bearing needles, when such rolling element guide rails are used as intended, the use of high-strength materials such as rolling bearing steel or ceramics should be provided in order to ensure a long service life for the rolling element guide rails. Profile grinding processes and hard milling can be used to machine such high-strength materials, whereby simultaneous (synchronous) machining of several rolling element guide rails, which are accommodated in the common panel, leads to cost savings in each case. In order to also make it cost-effective to remove the individual rolling element guide rails from the panel and to avoid impairments to the profile geometry of the individual rolling element guide rail when carrying out the release process, it is intended to incorporate fracture grooves as predetermined breaking points between the rolling element guide rails that form the panel, which have a considerably lower material thickness compared to the profile bodies. The material thickness in the area of the fracture groove between the rolling element guide rails is dimensioned in such a way that when bending forces are applied to the panel, fracture formation occurs reliably in the area of the fracture groove, while the remaining geometry of the respective profile body does not undergo any plastic deformation. As a result, each of the rolling element guide rails has at least one fracture edge. This breaking edge is arranged in the area of a guide surface of the profile body, whereby this guide surface is designed for a geometrically precisely defined mounting in a guide groove of a bearing housing. Since the profile body is to be received in the guide groove in a form-fitting manner, it has two guide surfaces, preferably aligned in mirror image to one another, with a breaking edge being assigned to at least one guide surface.

It is useful if the profile body extends along the straight line of movement between a first end face and a second end face and that an inclined surface is formed adjacent to the first end face and/or adjacent to the second end face, which is aligned at an acute angle to the rolling element running surface. When the rolling element guide rail is used in a recirculating ball bearing guide, this inclined surface enables a preferably linear increase in force or a linear decrease in force when the respective bearing ball is fed to or removed from the rolling element running surface in the course of its orbital movement. This avoids a sudden load for the respective bearing ball and for the rolling element running surface, thereby increasing the service life of the rolling element guide rail.

It is preferable that the profile body is made of a metallic material with a hardness greater than 54 HRC, preferably greater than 56 HRC, in particular greater than 58 HRC, or of a ceramic material.

The problem of the invention is also solved by a method for producing rolling element guide rails, which comprises the following steps: Clamping an underside of a plate-shaped material blank, which is produced from a metallic material with a hardness greater than 54 HRC or from a ceramic material, onto a grinding table of a grinding machine, in particular a surface grinding machine, wherein the material blank has a length which corresponds at least to the length of the rolling element guide rail and wherein the material blank has a width which corresponds to at least twice a width of the rolling element guide rail, carrying out a first grinding operation on an upper side of the material blank facing away from the underside with a profile grinding wheel, the width of which corresponds at least substantially to the width of the material blank and which is provided over its width with a profiling which corresponds to an upper side profiling for the at least two rolling element guide rails, a fracture groove being ground into the material blank by the profile grinding wheel between adjacent rolling element guide rails in each case.

In a further development of the method, it is provided that the grinding process is carried out as a superposition of a rotational movement of the profile grinding wheel about a rotational axis aligned parallel to the grinding table and a linear movement of the profile grinding wheel aligned transversely to the rotational axis and parallel to the grinding table, wherein a constant distance between the profile grinding wheel and the material blank is maintained on the upper side of the material blank in order to produce the rolling element running surfaces extending along the straight line of movement and wherein a preferably linear reduction in the distance between the profile grinding wheel and the material blank is carried out on a first end face and/or on a second end face of the material blank in order to form inclined surfaces adjacent to the rolling element running surfaces.

In a further embodiment of the invention, it is provided that, after the first grinding operation has been carried out, in particular after a second grinding operation has also been carried out to machine the underside of the material blank, a breaking operation is carried out to separate the adjacently arranged rolling element guide rails in the region of the respective fracture groove.

In the case of track and cam roller guides and profiled rail rolling guides, their movable or fixed elements are formed from at least two different materials, one of which is formed by hard raceway profiles suitable for rolling bearings and a second which provides a support structure for accommodating such raceway profiles and is mounted on linear ball bearings for round smooth and round profiled or non-circular smooth or non-circular profiled shafts, the force-absorbing parts of which are also made of hard raceway profiles suitable for rolling bearings.

The guide rails known from the state of the art are manufactured by means of a mostly machined receiving contour in extruded aluminum profiles and hard or glued-in, drawn profile strips rolled into them.

The disadvantage compared to ground solid steel rails is a reduction in precision and a reduction in the maximum possible service life resulting from the deteriorated geometry and surface roughness.

The carriages of recirculating and cage guidance systems often consist of locating bodies machined in the load area and ground insert profiles made of drawn and ground hard steel, even if they are moved on unground rail profiles.

Standard ball bushings made of solid, hard steel rings have also been replaced in many cases for linear ball bearings that have returns and deflections for movements on round shafts with similar support plates that are also drawn, unground and ground and absorb forces. The raceways of cold-rolled or cold-drawn steel inserts with forged contours, which are positioned and held in plastic support structures, allow a significantly higher force transmission compared to standard bushings due to their narrow curvatures.

For low load and running behavior requirements, inserts without reworking are sufficient. Precise solutions with reground profiles are also commercially available from many manufacturers.

Well-known solutions exist, for example, in the ISO series 3 at Bosch, Thomson, NB and others with one raceway per load-bearing plate in ground design, unground at Ewellix in series 1.

Solutions with two raceways per load-bearing plate can be found in series 3 at NB, Thomson, at Schaeffler and Exxellin in series 1, also in ground design.

As is generally recognized, the service life of linear guidance systems is determined by means of the calculations specified in ISO standards using the dynamic load rating and against overload using the static load rating.

In both standards, deviations in contour, surface quality and load-bearing components are not or only insufficiently covered. An exact comparison of different guide manufacturers is therefore hardly possible.

However, service life tests that go beyond the calculation standards have now shown that with a hardness of 58 HRC, high surface quality, contact ratio and precise contour achieved with current machining by grinding or hard milling, load ratings that are up to 25% higher than the calculations according to the ISO standard can be selected.

Under normal load conditions, the 25% increase in the load rating results in at least a doubling of the service life compared to raceways produced without cutting.

Raceway profiles produced without cutting for profiled rail guides and linear ball bearings for round shafts pass through several process stages with intermediate annealing in each case, also as the starting material for machining, as the positioning of the load-bearing components also requires exact dimensions outside the raceways for the connection to surrounding components.

This leads to material costs that are several times higher than for cold-rolled standard sheets or hot-rolled profiles.

The post-processing of the individual profiles necessary to achieve the above-mentioned optimum properties, which can only be achieved by machining, requires not only the expensive primary material but also a high level of effort due to the individual processing of separate individual profiles.

As a rule, complex special equipment is used for this purpose, which requires considerable capital expenditure and leads to a substantial increase in product costs due to the individual machining resulting from the individual profiles.

A further task of the invention is therefore to propose a method which leads to the achievement of the load ratings and service life values proven by the tests and substantially above those shown by the calculation according to the ISO standard, and which results in considerable cost savings compared to the state of the art.

For linear guides, roller guides, profiled rail guides and linear ball bearings for round shafts based on at least two different materials, the solution according to the invention comprises the manufacture of the load-bearing raceway areas necessary for achieving the specified high load ratings in only one or two machining processes, in each case involving several raceway profiles by parallel machining and producing all raceways and contact surfaces together.

The solution according to the invention is based on hard and load-bearing raceway profiles which are produced by machining, usually by grinding, and which have laterally grindable bevels for the contact surfaces in the surrounding parts together with the raceway and support sides and which are connected to each other with thin cross-sections via thin webs with grindable radii during the machining process, which are broken after machining, whereby protruding breakage volumes of the webs extend beyond the contact surfaces and are absorbed in free spaces of the connecting parts without contact.

The starting material can be, for example, hardenable, flat sheet metal, preferably for track profiles of rails or for linear ball bearings for shafts of size three small sizes or bushings of series 1, or a drawn or rolled profile produced with fewer features in a coarser tolerance or even a stamped part connecting several plates via webs can be selected as the starting material.

The raceway profiles for rails, support plates for profiled rails or linear ball bearings for round shafts are produced by simultaneously grinding several connected profiles next to each other on the raceway side and then, if machining is necessary, from two sides on the support side with profiled disks so that thin webs are created between the plates which, due to their shape, produce a defined fracture contour that protrudes beyond the support surfaces after fracture and is accommodated in a free space of the surrounding parts without contact.

There is also a particular advantage with guideways whose material consists of ceramic suitable for rolling bearings. As the grinding process is very complex in this case, parallel machining and separation by breaking leads to a significant reduction in costs.

As an alternative to the grinding process, machining can also be carried out with a defined cutting edge, e.g. hard milling. In this case, the inclination of the side surfaces can be dispensed with, but the connecting webs are executed in the same way.

### BRIEF DESCRIPTION OF THE DRAWINGS

Advantageous embodiments of the invention are shown in the drawing. Here shows:

FIG. 1 a composite profile rail guide in X arrangement with a rail base body and a guideway made of aluminum with rolled-in steel raceways in accordance with the proposed new manufacturing process with lugs and fracture contours accommodated in free spaces,

FIG. 2 a linear ball bearing for round shafts, with support plates manufactured from two sides, inserted into a cage, provided with inclined contact sides, having two raceways and provided with lugs received in free spaces,

FIG. 3 a guideway with slopes that can be ground on one side and connecting webs for roller guides and recirculating roller guides with a flat surface, which can be used in any arrangement in rail guides,

FIG. 4 a guideway with slopes on one side and connecting webs with two ball tracks each, which can be used in any arrangement in rail guides,

FIG. 5 a guideway with slopes on one side and connecting webs, each with one ball track, which can be used in any arrangement in rail guides,

FIG. 6 load-bearing support plates for linear ball bearings and round shafts and profiled rail guides, which can be tilted about the longitudinal axis or about the longitudinal axis and transverse axis with connecting webs and two ball tracks each with contact inclines from two machining directions,

FIG. 7 load-bearing support plates for linear ball bearings and round shafts and profiled rail guides which can be tilted about the longitudinal axis or about the longitudinal axis and transverse axis with connecting webs and one ball track each with contact angles from two machining directions,

FIG. 8 raceways for four-row profile rails and profile guide carriages which are supported against flat surfaces with thin, breakable connecting webs which are machined from two sides and a lateral extension which contains the break lines,

FIG. 9 a top view of the upper side of a plate-shaped material blank, the upper side of which has already been machined using the profile grinding process,

FIG. 10 an end view of an arrangement of several interconnected rolling element guide rails, which were produced from the material blank according to FIG. 9 by additional machining of an underside in the profile grinding process and can be combined in a subsequent step in a breaking process,

FIG. 11 an enlarged view of a rolling element guide rail after the rolling element guide rails have been separated as shown in FIG. 10,

FIG. 12 a sectional view of the rolling element guide rail as shown in FIG. 11,

FIG. 13 a schematic perspective view of a linear guideway with a circular cylindrical guide rod and a ball bushing mounted on the guide rod for linear movement and equipped with the rolling element guide rails according to the invention,

FIG. 14 a schematic perspective view of the ball bushing as shown in FIG. 13, and

FIG. 15 a sectional view of the ball bushing according to FIGS. 13 and 14.

### DETAILED DESCRIPTION OF THE INVENTION

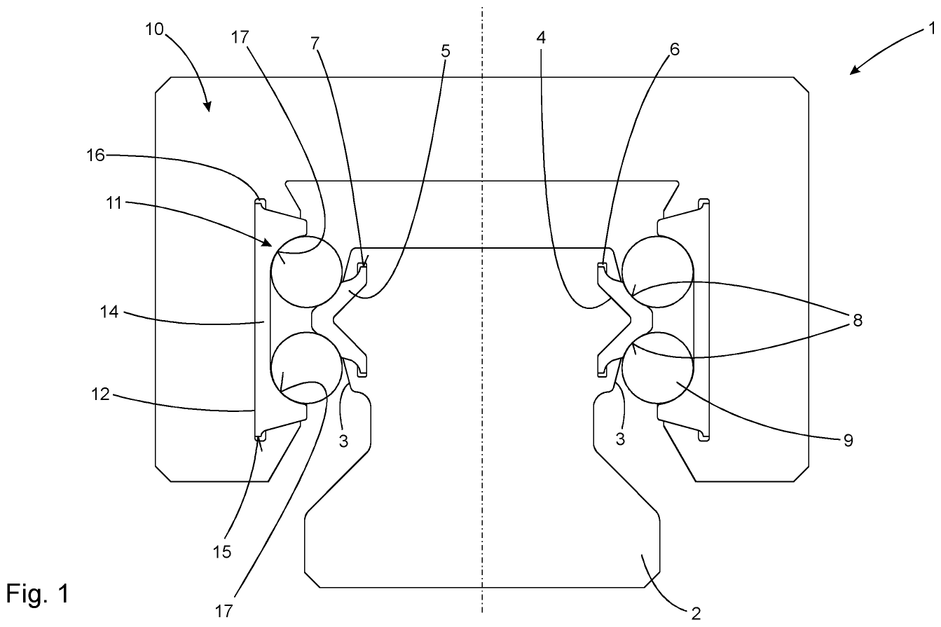

The composite profile rail guide 1 shown in FIG. 1 comprises a basic rail body 2, which can, for example, be manufactured as an extruded profile from an aluminum material and which extends orthogonally to the plane of representation of FIG. 1 along a straight line of movement (not shown). On opposite side surfaces 3 of the basic rail body 2, guide grooves 4 are formed in the basic rail body 2 in a mirror image of each other, which are profiled in such a way that they can be used to accommodate rolling element guide rails 5.

Each of the rolling element guide rails 5 comprises a profile body 51, which has the profiling shown in FIG. 1, which essentially corresponds to the profiling of the guide groove 4 also shown in FIG. 1. In particular, the profile body 51 comprises two guide surfaces 52, 53, which are aligned in mirror image to one another by way of example only and are designed for flat contact with corresponding inner surfaces of the guide groove 4. This makes it possible for the rolling element guide rails 5 to be inserted into the respective guide groove 4 in order to be fixed to the rail base body 2 along the straight line of movement (not shown) and thus perpendicular to the plane of representation of FIG. 1 and then to be fixed by plastic deformation of the rail base body 2.

As can be seen from the illustration in FIG. 1, the profiling of the guide groove 4 differs in some areas from the profiling of the rolling element guide rail 5, whereby a cavity 6 is formed after the rolling element guide rail 5 is inserted into the guide groove 4, which makes it possible to accommodate a breaking edge 7 formed on the side of the rolling element guide rail 5 with a large geometric tolerance.

By way of example only, the rolling element guide rails 5 are each provided with a mirror-symmetrical profile, whereby each of the rolling element guide rails 5 has, by way of example, two rolling element running surfaces 8 on the profile body 51, which are profiled concavely as circular arc sections and are provided for a rolling movement of spherical rolling elements 9.

The rolling elements 9 are accommodated in two ball recirculation guides 11, which are arranged mirror-symmetrically to each other and are only shown schematically, and which are fixed to a guide carriage 10. The guide carriage 10 is made purely by way of example from an extruded aluminum profile, the profile of which extends along the straight line of movement and thus transversely to the plane of representation in FIG. 1. The carriage 10 is provided with two guide grooves 12, which are aligned mirror-symmetrically to each other and are designed to accommodate rolling element guide rails 14. The profiles of the guide grooves 12 and the rolling element guide rails 14 are adapted to each other in such a way that a hollow space 16 is created for the at least one breaking edge 15 of the rolling element guide rail 14, which serves to accommodate the geometrically indeterminate breaking edge 15, which must be taken into account with a large tolerance.

The rolling element running surfaces 17 on the profile body 51 of the respective rolling element guide rails 14 are also aligned with mirror symmetry to one another and are profiled purely by way of example as circular arc sections and are used for a rolling movement of the spherically designed rolling elements 9. Furthermore, the profiled bodies 51 of the respective rolling element guide rails 14 are each provided with the first guide surface 51 and the second guide surface 52, which are designed purely by way of example as flat surfaces.

As an example, the rolling element running surfaces 8 and the rolling element running surfaces 17 are aligned with each other in such a way that the rolling elements 9 form an X arrangement.

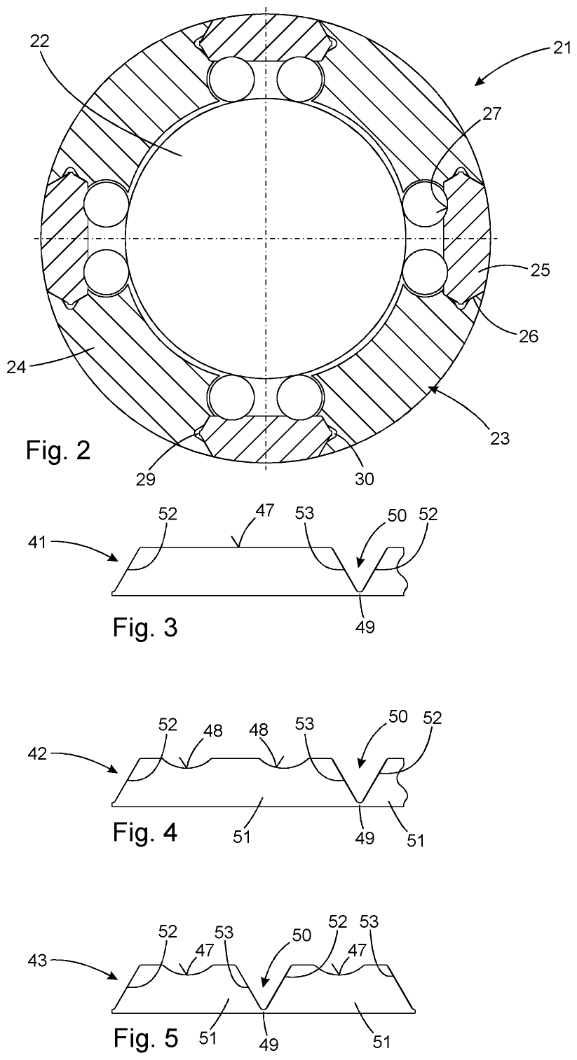

The linear ball bearing 21 shown purely schematically in FIG. 2 comprises a guide rod 22, also known as a shaft, which extends transversely to the plane of representation of FIG. 2 along a line of motion not shown and is of circular cylindrical cross-section, for example made of a metallic material, in particular steel. A ball bushing 23 is accommodated linearly on the guide rod 22 and comprises a base body 24, which is essentially circular in shape and can also be referred to as a cage, as well as rolling element guide rails 25, which are fixed to the base body 24 in a form-fitting manner and are arranged at a 90-degree angular pitch by way of example only, and which can also be referred to as support plates. The rolling element guide rails 25 are each part of a recirculating ball bearing guide (not shown in detail) and are each received in a guide groove 26 in the base body 24 in certain areas. Here, a profiling of the respective rolling element guide rail 25 and a profiling of the respective guide groove 26 are adapted to one another in such a way that a cavity 30 results for the at least one breaking edge 29 of the rolling element guide rail 25, which serves to accommodate the geometrically indeterminate breaking edge 29 to be taken into account with great tolerance.

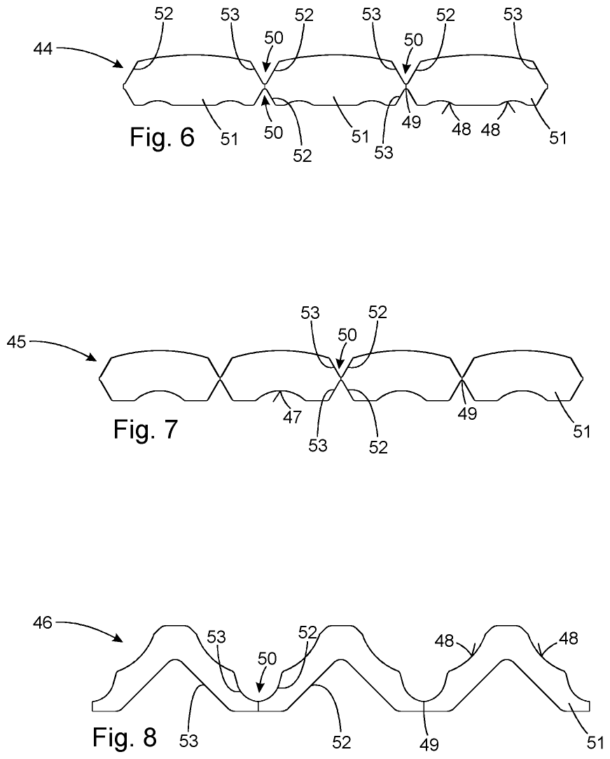

FIGS. 3 to 8 show differently profiled rolling element guide rails 41 to 46, on each of whose profiled bodies 51 one or more, in particular two, rolling element running surfaces 47 or 48 are formed and which are intended to be manufactured in a surface grinding process using a profile grinding wheel. For this purpose, it is provided that, in order to carry out the profiling process with the profile grinding wheel, at least two rolling element guide rails 41 to 46 are each machined in a common panel, i.e. a one-piece composite, and are only separated at predetermined breaking points after the profiling process has been completed, whereby only roughly predetermined breaking edges are formed geometrically. In order to form these predetermined breaking surfaces 49, it is intended to select the profiling of the respective rolling element guide rails 41 to 46 in such a way that a purely exemplary V-shaped profiled fracture groove 50 is formed between rolling element guide rails 41 arranged adjacent to each other in a panel. A profiling of this fracture groove 50 is selected in such a way that when a force is applied to the rolling element guide rails 41 to 46, a reliable crack is formed along the fracture groove 50 and the remaining profiling of the rolling element guide rails 41 to 46 does not undergo any plastic deformation.

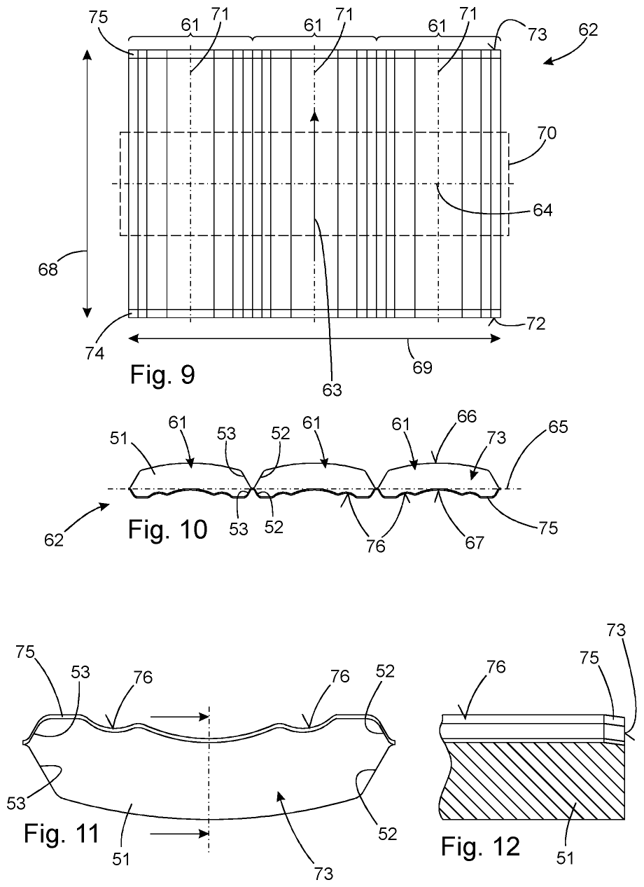

FIGS. 9 and 10 show a purely exemplary arrangement of several rolling element guide rails 61 in a panel 62. In practice, this means that a plate made of a rolling bearing steel or a ceramic material, which can also be referred to as a material blank, is first fixed with an underside on a surface of a grinding table, which is not shown, of a grinding machine, which is also not shown.

By way of example only, it is provided here that a length extension 68 of the material blank corresponds to a length of the rolling element guide rails 61 to be produced and that a width extension of the material blank corresponds to an integer multiple of a width of the rolling element guide rail 61 to be produced. By way of example only, the width extension 69 of the blank 62 is selected in such a way that a synchronous profiling of a total of three rolling element guide rails 61 can be carried out.

After the fixing process has been carried out on the grinding table, a grinding operation is carried out on the upper side of the groove 62 with a profile grinding wheel, whereby the upper side profiling 66 formed above a machining plane 65 can be produced purely by way of example. This surface profiling comprises, for example, the guide surfaces 52, 53 formed on the side of the profile body 51, which can be used to precisely fix the respective rolling element guide rail 61 in a bearing housing. Preferably, the first and second guide surfaces 42, 53 of adjacent rolling element guide rails 61 arranged in the groove 62 are aligned at an acute angle 54 to one another, which favors the production of the fracture groove 50 in the profile grinding process. If the profiling of the groove 62 is to be carried out by a hard milling process, the guide surfaces 52, 53 can also be aligned parallel or at least almost parallel to each other.

In a subsequent machining step, the panel 62 is turned over in such a way that the upper side is now fixed on the grinding table, which is not shown, and machining of the underside of the panel 62 can be carried out with a profile grinding wheel 70, which is only symbolically indicated in FIG. 9. In this case, the profile grinding wheel 70 is rotated about an axis of rotation 64, which is aligned transversely to a profile axis 71 of the rolling element guide rails 61 and moves linearly at a constant distance from the panel 62 in a machining direction 63 along the profile axis 71 in order to introduce the underside profiling 67 into the panel 62.

In the region of a first end face 72 of the panel 62 aligned transversely to the profile axis 71 and in the region of a second end face 73 of the panel 62 aligned transversely to the profile axis 71, a purely exemplary linear reduction in the distance between the profile grinding wheel 70 and the panel 62 takes place in addition to the linear movement of the profile grinding wheel 70, in order to form the first and second inclined surfaces 74, 75 shown in more detail in FIGS. 11 and 12. These inclined surfaces 74, 75 are advantageous when the rolling element guide rails 61 are used in a recirculating ball bearing system, as shown in more detail in FIGS. 14 and 15, since the recirculating balls, when subjected to relative movement along the rolling element guide rails 76, are located both in a run-in area, for example in the area of the first end face, and in the area of the second end face, which can be arranged, for example, in the region of the first end face 72, as well as in a run-out region, which can be arranged, for example, in the region of the second end face 73, the rotating balls experience a constantly increasing or constantly decreasing load instead of an abrupt load.

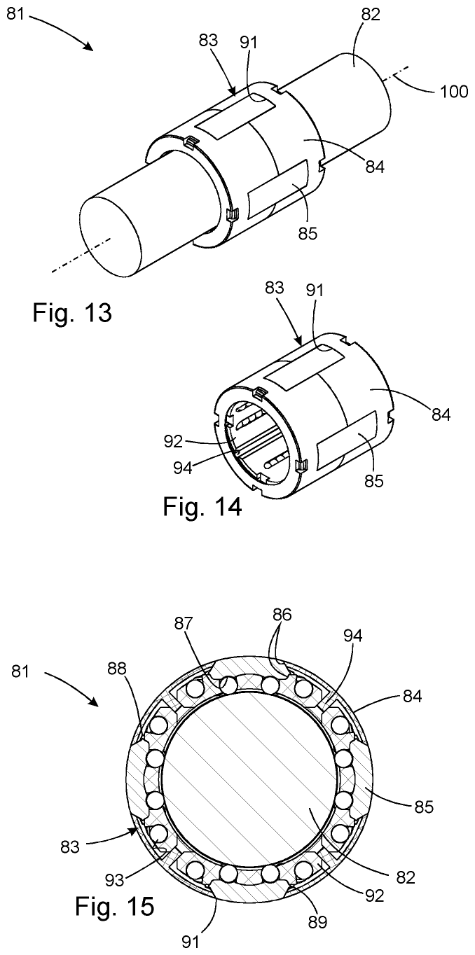

The linear ball bearing 81 shown in more detail in FIGS. 13 to 15 essentially corresponds to the linear ball bearing 21 shown in FIG. 2 and comprises a guide rod 82 with a circular cylindrical profile and extending along a straight line of movement 100. A ball bushing 83 mounted for linear displacement is accommodated on the guide rod 82 and has an essentially circular cylindrical base body 84 and rolling element guide rails 85 arranged in the base body 84 at a 90-degree angular pitch. Purely by way of example, each of the rolling element guide rails 85 is accommodated in a slot-shaped recess 91 in the base body 84, which recess extends along the straight line of movement 100, and in a ball guide 92 which is substantially in the form of a circular ring section, is manufactured purely by way of example from a plastic material and is supported on guide webs 94 projecting radially inwards from an inner surface 93 of the base body 84. A cavity 88 is formed between the ball guide 92 and the base body 84, which is provided to accommodate the geometrically only roughly defined and highly toleranced breaking edge 89 of the respective rolling element guide rail 85. The cavity 88 is dimensioned in such a way that it can reliably accommodate the geometrically largely undefined extension on the first guide surface 52 and/or on the second guide surface 53, which is limited by the breaking edge 89. Furthermore, the dimensional tolerances for the rolling element guide rail 85 and for the guide groove 86 are dimensioned in such a way that precise guidance between these two components is always ensured.

1-14. (canceled)

15. A rolling element guide rail for a linear rolling bearing, comprising a profile body on which at least one rolling element running surface extends along a straight line of movement with a constant profiling and on which two guide surfaces each extend along the straight line of movement with a constant profiling, wherein a breaking edge is formed on at least one of the guide surfaces.

16. The rolling element guide rail according to claim 15, wherein the profile body extends along the straight line of movement between a first end face and a second end face and wherein an inclined surface is formed adjacent to the first end face and/or wherein an inclined surface is formed adjacent to the second end face, which inclined surface is aligned at an acute angle to the rolling element running surface.

17. The rolling element guide rail according to claim 15, wherein the profile body is made of a metallic material with a hardness greater than 54 HRC or of a ceramic material.

18. A method for manufacturing a plurality of rolling element guide rails, comprising the steps:
clamping an underside of a plate-shaped material blank, which is made of a metallic material with a hardness greater than 54 HRC or of a ceramic material, onto a grinding table of a grinding machine, the plate-shaped material blank having a length which is at least equal to the length of the rolling element guide rail to be manufactured and wherein the plate-shaped material blank has a width which is at least twice a width of the rolling element guide rail to be manufactured,
carrying out a first grinding operation on an upper side of the plate-shaped material blank facing away from the underside with a profiled grinding wheel, a width of grinding wheel corresponding at least substantially to the width of the plate-shaped material blank,
wherein the grinding wheel is provided over its width with at least two profiles, each of the profiles corresponding to an upper side profiling for the rolling element guide rail to be manufactured,
wherein a fracture groove is ground into the plate-shaped material blank by the profiled grinding wheel between adjacent rolling element guide rails.

19. The method according to claim 18, wherein the grinding process is carried out as a superposition of a rotational movement of the profiled grinding wheel about a rotational axis aligned parallel to the grinding table and a linear movement of the profiled grinding wheel aligned transversely to the rotational axis and parallel to the grinding table, wherein, in order to produce the rolling element running surfaces on the upper side of the plate-shaped material blank, a constant distance between the profiled grinding wheel and the plate-shaped material blank is maintained.

20. The method according to claim 19, wherein a linear reduction in the distance between the profiled grinding wheel and the plate-shaped material blank is carried out on a first end face and/or on a second end face of the plate-shaped material blank to form an inclined surface adjoining the rolling element running surfaces.

21. The method according to claim 18, wherein subsequently to carrying out the first grinding operation a breaking operation is carried out for separating the adjacent rolling element guide rails in the region of the respective fracture groove.
